(19) United States
(12) Patent Application Publication
(10) Pub. No.: US 2011/0117859 A1
(43) Pub. Date: May 19, 2011

(54) WIRELESS COMMUNICATION DEVICE, WIRELESS COMMUNICATION METHOD, PROGRAM, AND INTEGRATED CIRCUIT

(76) Inventors: Koichiro Tanaka, Hyogo (JP); Akihiko Shiotsuki, Osaka (JP)

(21) Appl. No.: 13/054,093

(22) PCT Filed: Jul. 15, 2009
(86) PCT No.: PCT/JP2009/003320

§ 371 Date: Jan. 14, 2011

(30) Foreign Application Priority Data
Jul. 15, 2008 (JP) 2008-183474

(51) Int. Cl. H04W 24/04; H04W 72/12

(52) U.S. Cl. 455/67.13; 455/69

(57) ABSTRACT

A first wireless communication device (1) performs wireless communication with a second wireless communication device (2) which is connected via a wireless network. More specifically, the first wireless communication device (1) includes a wireless communication unit which transmits and receives a wireless signal, and a transmission rate controlling unit which controls the second wireless communication device (2) so that a transmission rate of a wireless signal, which is transmitted by the second wireless communication device (2) and received by a wireless transmission and reception unit, becomes constant.

### TECHNICAL FIELD

The present invention relates to a wireless communication method and a wireless communication device which allow a transmission rate to vary.

### BACKGROUND ART

Generally, in wireless communication of data, a transmission device converts original data into a wireless signal, and transmits the wireless signal through an antenna. On the other hand, a reception device receives the wireless signal through an antenna, and restores the original data by demodulating and decoding the received wireless signal.

As a conventional wireless communication device, there is a receiving device which is provided with a plurality of antennas, and which selects an antenna which allows restoration with fewer errors, in order to perform reliable wireless communication. (for example, refer to PTL 1).

More specifically, the conventional wireless communication device detects a bit error rate of a received signal and, when the detected bit error rate exceeds a desired bit error rate value, switches antennas so that an antenna that is different from the antenna currently being used is used for signal reception. With this structure, it is possible to select the antenna in a good reception condition. As a result, an advantageous effect of increasing data transmission throughput as a whole has been produced.

### CITATION LIST

### Patent Literature

### [PTL 1]

Japanese Unexamined Patent Application Publication No. 10-126322 (Page 6, FIG. 1)

### SUMMARY OF INVENTION

### Technical Problem

However, the conventional structure cannot be accurately applied to a case where a wireless signal which has been transmitted by the wireless communication device which has a function of changing a wireless communication speed (also called “transmission rate”) of the wireless signal is received. Here, the wireless communication speed is determined by a multi value of modulation method, such as QPSK (Quadrature Phase Shift Keying) or 16QAM (Quadrature Amplitude Modulation), or a coding rate for an error correction (such as ½ or ¾ of convolutional code), and is also referred to as physical layer speed (PHY RATE).

In other words, a change in the wireless communication speed during the bit error rate detection changes noise immunity and the like, thereby changing the relationship between the status of the wireless communication and the bit error rate. Due to this, the conventional structure has a problem that an accurate selection of a suitable antenna based on the bit error rate is difficult.

The present invention has been devised to solve the conventional problem, and has an object to provide a wireless communication device which can control a transmission rate of a wireless signal transmitted by a counterpart device.

### Solution to Problem

A wireless communication device according to a first aspect of the present invention performs wireless communication with an other wireless communication device connected via a wireless network. More specifically, the wireless communication device includes: a wireless transmission and reception unit which transmits and receives a wireless signal; and a transmission rate controlling unit which controls the other wireless communication device so that a transmission rate of the wireless signal, which is transmitted by the other wireless communication device and received by said wireless transmission and reception unit, becomes constant. Controlling the transmission rate of the wireless signal transmitted from the counterpart device as described above is advantageous, for example, when the wireless communication device measures the communication status with the counterpart device.

Further, the wireless communication device may includes a response generating unit which generates a response signal for notifying the other wireless communication device of the reception of the wireless signal, and causes the wireless transmission and reception unit to transmit the response signal. The transmission rate controlling unit may increase or decrease a rate of the response signal with respect to the wireless signal so that the transmission rate of the other wireless communication device is kept constant. This eliminates the necessity for the counterpart device to recognize that the transmission rate is deliberately controlled. In other words, the wireless communication device can also control the transmission rate of an existing wireless communication device.

More specifically, the transmission rate controlling unit may decrease a response rate which is a rate at which the wireless transmission and reception unit transmits the response signal generated by the response generating unit, when the transmission rate exceeds a predetermined target value.

Further, the transmission rate controlling unit may increase the response rate when the transmission rate falls short of the predetermined target value, and cause the wireless transmission and reception unit to transmit a transmission-rate-increase request for causing the other wireless communication device to increase the transmission rate. Thus, it is possible to prevent the transmission rate from falling short of the target value.

With the structure described above, the wireless communication device can control the transmission rate of the data transmitted from the counterpart device. It is to be noted that the existing wireless communication device decreases the transmission rate relatively quickly when the response rate of the response signal is decreased. On the other hand, the existing wireless communication device does not increase the transmission rate immediately even when the response rate is increased. Thus, when it is desired to increase the transmission rate, “transmission-rate-increase request” may be explicitly transmitted.

In addition, it is desirable that the transmission rate controlling unit sets the response rate to 50% or greater. The response rate less than 50% may significantly obstruct actual communication.

In addition, the wireless transmission and reception unit may include an antenna which has a plurality of directivities that can be mutually switched (i.e., multi directional antenna). Further, the wireless communication device may include a directivity selection unit which performs a directivity selection processing of measuring a bit error rate while sequentially switching the directivities of the antenna and selecting a directivity with a lowest bit error rate as a directivity of the antenna. It is preferable that the transmission rate controlling unit controls the other wireless communication device so that the transmission rate is kept constant during the directivity selection processing.

With this, the transmission rate of the data transmitted from the counterpart device becomes constant while the directivity selection processing is performed, and thus, the wireless communication device can measure the bit error rate of each directivity of the antenna under the same condition. As a result, the wireless communication device can select the directivity suitable for the current communication status.

In addition, the transmission rate controlling unit may cause the wireless transmission and reception unit to transmit a transmission-rate-fixation request for causing the other wireless communication device to fix the transmission rate.

A wireless communication device according to a second aspect of the present invention is the other communication device connected with the wireless communication device described above via a wireless network. More specifically, the other communication device includes: a wireless transmission and reception unit which transmits and receives a wireless signal; a transmission rate setting unit which sets a transmission rate of the wireless signal, and causes the wireless transmission and reception unit to transmit the wireless signal at the set transmission rate; and a transmission rate controlling unit which prohibits, in response to the reception of the transmission-rate-fixation request, the transmission rate setting unit from changing the transmission rate.

The wireless communication device can also control the transmission rate of the data transmitted from the counterpart device by explicitly transmitting the “transmission-rate-fixation request” as described above. It is to be noted that, when ending the transmission rate control, the wireless communication device may transmit the “transmission-rate-fixation-cancellation request”.

A wireless communication method according to a third aspect of the present invention performs wireless communication with an other wireless communication device connected via a wireless network. More specifically, the wireless communication method includes: transmitting and receiving a wireless signal, and controlling the other wireless communication device so that a transmission rate of the wireless signal; which is transmitted by the other wireless communication device and received in the transmitting and receiving, becomes constant.

A program according to a fourth aspect of the present invention causes a computer to perform wireless communication with an other wireless communication device connected via a wireless network. More specifically, the program includes transmitting and receiving a wireless signal, and controlling the other wireless communication device so that a transmission rate of the wireless signal, which is transmitted by the other wireless communication device and received in the transmitting and receiving, becomes constant.

An integrated circuit according to a fifth aspect of the present invention performs wireless communication with an other wireless communication device connected via a wireless network. More specifically, the integrated circuit includes a wireless transmission and reception unit which transmits and receives a wireless signal, and a transmission rate controlling unit which controls the other wireless communication device so that a transmission rate of the wireless signal, which is transmitted by the other wireless communication device and received by the wireless transmission and reception unit, becomes constant.

It is to be noted that the present invention may be realized not only as a wireless communication device but also as an integrated circuit which achieves above described functions, and as a program which causes a computer to perform such functions. And it goes without saying that such a program can be distributed through recording media such as a CD-ROM and transmission media such as the Internet.

### Advantageous Effects of Invention

The wireless communication device according to the present invention can control the transmission rate of the wireless signal transmitted by the counterpart device.

### BRIEF DESCRIPTION OF DRAWINGS

FIG. 1 is a block diagram showing an example of a structure of a wireless communication system and a wireless communication device according to the present invention.

FIG. 2 is a block diagram showing an example of a structure of a transmission-rate-fixation requesting unit according to Embodiment 1 of the present invention.

FIG. 3 is a block diagram showing an example of a structure of a second wireless communication device.

FIG. 4 is a flowchart showing antenna switching operation.

FIG. 5 is a block diagram showing an example of a structure of a portion corresponding to a group of antennas and an antenna selector switch according to the present invention.

FIG. 6 is a block diagram showing an example of a structure of a portion corresponding to the group of antennas and the antenna selector switch according to the present invention.

FIG. 7 is a block diagram showing an example of a structure of a portion corresponding to the group of antennas and the antenna selector switch according to the present invention.

FIG. 8 is a block diagram showing an example of a structure of the transmission-rate-fixation requesting unit according to Embodiment 2 of the present invention.

FIG. 9 is a block diagram showing an example of a structure of a second wireless communication device.

FIG. 10 is a flowchart showing antenna switching operation.

FIG. 11 is a flowchart showing a transmission rate adjustment processing.

FIG. 12 is a diagram showing a relationship between a response rate and a response signal.

### DESCRIPTION OF EMBODIMENTS

Hereinafter, the embodiments of the present invention will be described with reference to the drawings.

### Embodiment 1

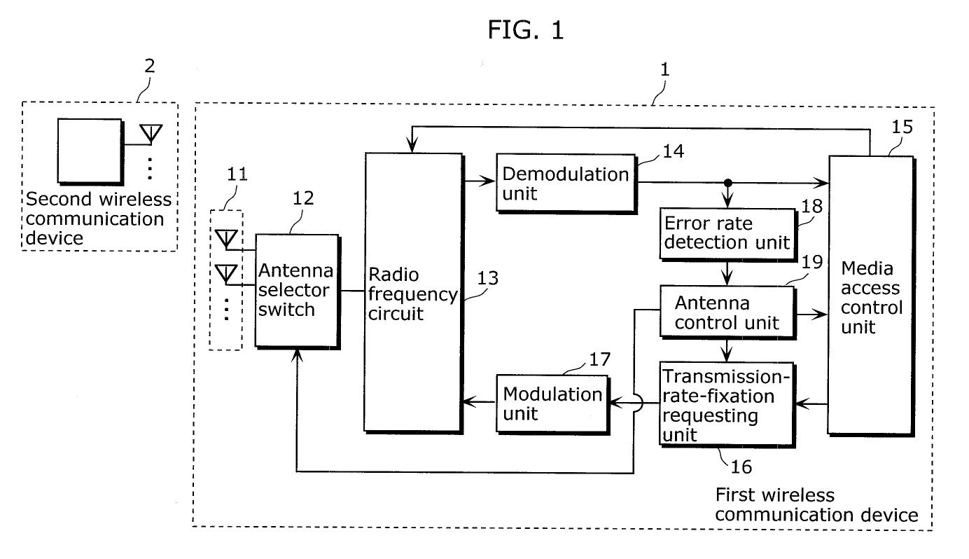

FIG. 1 is a block diagram showing an example of a structure of first and second wireless communication devices 1 and 2 which are included in a wireless communication system according to Embodiment 1 of the present invention.

As shown in FIG. 1, wireless communication between the first wireless communication device 1 and the second wireless communication device 2 is described in Embodiment 1.

As shown in FIG. 1, the first wireless communication device 1 includes: a group of antennas 11; an antenna selector switch 12; a radio frequency circuit 13; a demodulation unit 14; a media access control unit 15; a transmission-rate-fixation requesting unit 16; a modulation unit 17; an error rate detection unit 18; and an antenna control unit 19. It is to be noted that the group of antennas 11, the antenna selector switch 12, the radio frequency circuit 13, the demodulation unit 14, and the modulation unit 17 constitute a wireless transmission and reception unit (not shown) which transmits and receives a wireless signal.

In FIG. 1, the group of antennas 11 includes a plurality of antennas having mutually different directivity. Each antenna is connected to the antenna selector switch 12. The antenna selector switch 12 selects one of the antennas from among the group of antennas 11 according to an instruction from the antenna control unit 19. Then, the antenna selector switch 12 outputs to the radio frequency circuit 13 a radio frequency signal received through the selected antenna. In addition, the antenna selector switch 12 outputs to the selected antenna a radio frequency modulated transmission signal input from the radio frequency circuit 13.

The radio frequency circuit 13 controls transmission and reception mode of the antenna according to a mode control signal output from the media access control unit 15. More specifically, when a control mode is a reception mode, the radio frequency circuit 13 converts the radio frequency signal output from the antenna selector switch 12 into a modulated reception signal, and then outputs the modulated reception signal to the demodulation unit 14. On the other hand, when the control mode is a transmission mode, the radio frequency circuit 13 converts the modulated transmission signal input from the modulation unit 17 into a radio frequency signal, and then outputs the radio frequency signal to the antenna selector switch 12.

The demodulation unit 14 demodulates (with or without error correction) the modulated reception signal input from the radio frequency circuit 13, and then outputs the demodulated reception signal as reception data. The error rate detection unit 18 detects an error rate of the reception data input from the demodulation unit 14.

The antenna control unit (directivity selection unit) 19 controls the antenna selector switch 12, the media access control unit 15, and the transmission-rate-fixation requesting unit 16 according to the error rate detected by the error rate detection unit 18. More specifically, the antenna control unit 19 performs an directivity selection processing of measuring a bit error rate while sequentially switching the directivities of antenna and selecting the directivity with the lowest bit error rate as the directivity of the antenna.

The media access control unit 15 outputs the reception data input from the demodulation unit 14 to an external device such as a speaker (not shown) which is connected to the first wireless communication device 1. In addition, the media access control unit 15 transmits the data input from the external device such as a microphone (not shown) to the transmission-rate-fixation requesting unit 16 as transmission data. Moreover, the media access control unit 15 also functions as a response generating unit which generates a response signal (confirmation response signal, typically, an Ack) for notifying the second wireless communication device 2 of reception of a wireless signal, and outputs the generated response signal to the transmission-rate-fixation requesting unit 16. It is to be noted that the Ack is a response signal for notifying the second wireless communication device 2 that the media access control unit 15 has correctly processed the reception data input from the demodulation unit 14. Furthermore, the media access control unit 15 outputs to the radio frequency circuit 13 the mode control signal according to the instruction from the antenna control unit 19.

When the wireless communication device transmits the Ack signal, the data input from the external device, and after-mentioned transmission-rate-fixation request or transmission-rate-fixation-cancellation request, the media access control unit 15 outputs the mode control signal indicating the transmission mode. The media access control unit 15 outputs the mode control signal indicating the reception mode with timings other than the above, regardless of whether a modulation signal is actually being received or not.

The transmission-rate-fixation requesting unit 16 outputs to the modulation unit 17 either the data input from the media access control unit 15 or data generated by itself, based on the control by the antenna control unit 19. In addition, the transmission-rate-fixation requesting unit (transmission rate controlling unit) 16 controls the second wireless communication device 2 so that a transmission rate of the wireless signal, which is transmitted by the second wireless communication device 2 and received through the antenna, becomes constant. More specifically, the transmission-rate-fixation requesting unit 16 outputs to the modulation unit 17 the transmission-rate-fixation request for causing the second wireless communication device 2 to fix the transmission rate.

The modulation unit 17 modulates the data input from the transmission-rate-fixation requesting unit 16 into the modulated transmission signal, and outputs the modulated transmission signal to the radio frequency circuit 13. In addition, the modulation unit 17 determines the transmission rate of the modulated transmission signal (modulation method), stores the determined transmission rate in a header part of the modulated transmission signal, and outputs the modulated transmission signal to the radio frequency circuit 13. Further, the modulation unit 17 can change (increase/decrease) the transmission rate depending on the communication status and the like. For example, the modulation unit 17 can increase the transmission rate when the communication status is good, and decrease the transmission rate when the communication status is deteriorated.

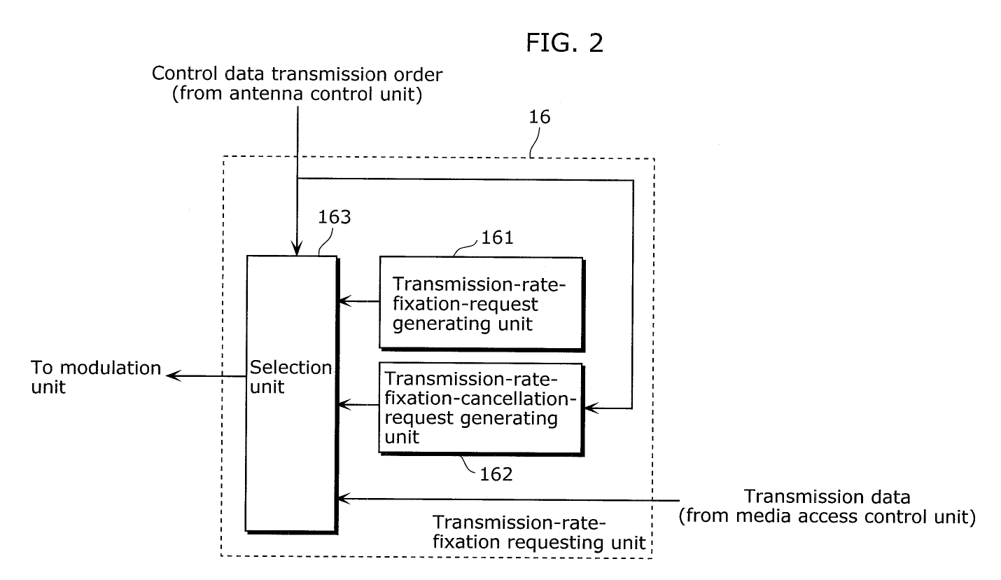

FIG. 2 is a block diagram showing in detail an example of a structure of the transmission-rate-fixation requesting unit 16.

In FIG. 2, a transmission-rate-fixation-request generating unit 161 and a transmission-rate-fixation-cancellation-request generating unit 162 generate the transmission-rate-fixation request and transmission-rate-fixation-cancellation request, respectively, according to a control data transmission order input from the antenna control unit 19. According to the control data transmission order provided by the antenna control unit 19, a selection unit 163 selects one of the transmission-rate-fixation request provided by the transmission-rate-fixation-request generating unit 161, the transmission-rate-fixation-cancellation request provided by the transmission-rate-fixation-cancellation-request generating unit 162, and the transmission data provided by the media access control unit 15, and outputs the selected one to the modulation unit 17.

It is to be noted that the transmission-rate-fixation-request generating unit 161 and the transmission-rate-fixation-cancellation-request generating unit 162 may constantly generate the control data regardless of content of the instruction provided by the antenna control unit 19, or may generate the control data only when the instruction requires the transmission-rate-fixation-request generating unit 161 or the transmission-rate-fixation-cancellation-request generating unit 162 to generate the control data. Furthermore, the transmission-rate-fixation-request generating unit 161 and the transmission-rate-fixation-cancellation-request generating unit 162 may pre-store and, as necessary, read out the transmission-rate-fixation request and the transmission-rate-fixation-cancellation request.

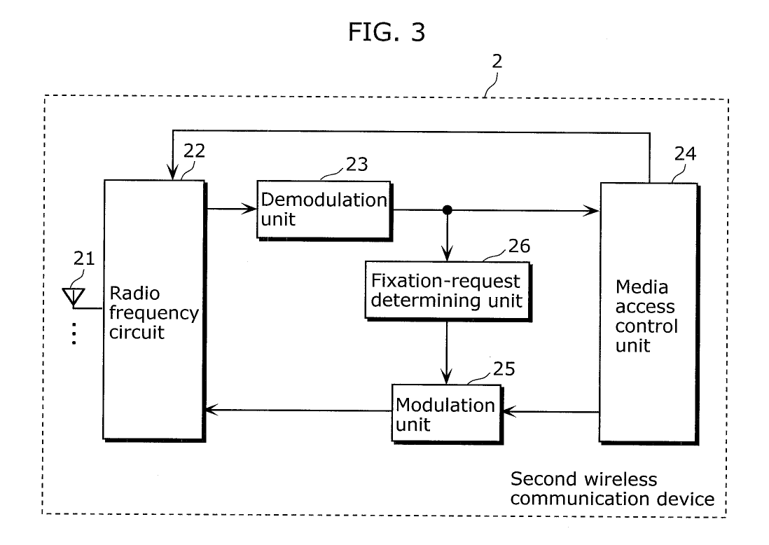

FIG. 3 is a block diagram showing an example of a structure of the second wireless communication device 2.

As shown in FIG. 3, the second wireless communication device 2 includes: an antenna 21; a radio frequency circuit 22; a demodulation unit 23; a media access control unit 24; a modulation unit 25; and a fixation-request determining unit 26.

In FIG. 3, the antenna 21 may include a single antenna or a plurality of antennas. The radio frequency circuit 22 controls the transmission and reception mode of the antenna according to the mode control signal output from the media access control unit 24. More specifically, when a control mode is a reception mode, radio frequency circuit 22 converts the radio frequency signal received through the antenna 21 into the modulated reception signal, and then outputs the modulated reception signal to the demodulation unit 23. On the other hand, when the control mode is the transmission mode, the radio frequency circuit 22 converts the modulated transmission signal input from the modulation unit 25 into the radio frequency signal, and outputs the radio frequency signal to the antenna 21. The demodulation unit 23 demodulates the modulated reception signal input from the radio frequency circuit 22.

The modulation unit 25 modulates the data input from the media access control unit 24 into the modulated transmission signal, and outputs the modulated transmission signal to the radio frequency circuit 22. In addition, the modulation unit 25 also functions as a transmission rate setting unit which determines the transmission rate of the modulated transmission signal (modulation method), stores the determined transmission rate in a header part of the modulated transmission signal, and outputs the modulated transmission signal to the radio frequency circuit 22. Furthermore, the modulation unit 25 can change (increase/decrease) the transmission rate depending on the status of communication and the like. For example, the modulation unit 25 can increase the transmission rate when the communication status is good, and decrease the transmission rate when the communication status is deteriorated.

The fixation-request determining unit 26 functions as the transmission rate controlling unit which determines the reception data input from the demodulation unit 23, and controls the modulation unit 25 based on the determined result. More specifically, in response to the reception of the transmission-rate-fixation request, the fixation-request determining unit 26 prohibits the modulation unit 25 from changing the transmission rate. In addition, in response to the reception of the transmission-rate-fixation-cancellation request, the fixation-request determining unit 26 allows the modulation unit 25 to change the transmission rate.

The media access control unit 24 outputs the reception data input from the demodulation unit 23 to an external device such as a speaker (not shown) which is connected to the second wireless communication device 2, or outputs, as the transmission data, to the modulation unit 25 the data, Ack or the like which is input from the external device such as a microphone (not shown).

Hereinafter, operations of the first and second wireless communication devices 1 and 2 according to Embodiment 1 are described.

In Embodiment 1, a case where the first wireless communication device 1 switches the antennas while the wireless communication is performed between the first wireless communication device 1 and the second wireless communication device 2 is described as an example.

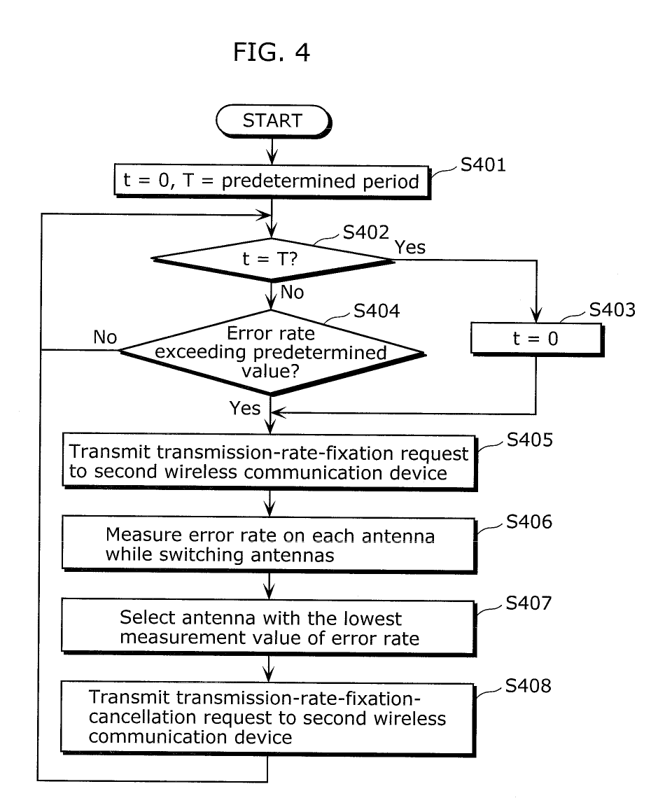

Hereinafter, the operations of Embodiment 1 are described in detail with reference to the flowchart in FIG. 4. It is to be noted that the flowchart in FIG. 4 describes the operations of the first wireless communication device 1.

Now, it is assumed that the wireless communication is performed between the first wireless communication device 1 and the second wireless communication device 2 and that each of components in the first wireless communication device 1 and the second wireless communication device 2 performs the necessary processing.

(Step S401) The antenna control unit 19 sets t(≧0)=0 and T(>0)=predetermined period so that the antenna control unit 19 can start a search for the suitable antenna periodically.

(Step S402) The antenna control unit 19 checks whether the predetermined time has passed (whether t=T). When t=T (Yes in S402), the processing proceeds to Step S403. When t≠T (No in S402), the processing proceeds to Step S404.

(Step S403) Because the predetermined time has passed, the antenna control unit 19 starts the search for the antenna. The antenna control unit 19 sets t=0, and causes the processing to proceed to Step S405.

(Step S404) When the reception data is input from the demodulation unit 14, the error rate detection unit 18 calculates an error rate such as a bit error rate or a packet error rate of the reception data, and determines whether the calculated error rate exceeds a predetermined value. The error rate may be calculated by any calculation method. For example, the error rate may be measured per bit, per packet, per certain amount of reception data, or at a certain time interval. The error rate detection unit 18 causes the processing to proceed to Step 5405 when the calculated error rate exceeds the predetermined value (Yes in S404), and the error rate detection unit 18 causes the processing to return to Step S402 when the calculated error rate is equal to or smaller than the predetermined value (No in S404).

(Step S405) The antenna control unit 19 transmits to the second wireless communication device 2 the transmission-rate-fixation request, and causes the processing to proceed to Step S406.

Hereinafter, operations in Step S405 are described in detail.

The antenna control unit 19 instructs the transmission-rate-fixation requesting unit 16 to generate the transmission-rate-fixation request. At this time, upon receiving the instruction from the antenna control unit 19, the transmission-rate-fixation requesting unit 16 causes the transmission-rate-fixation-request generating unit 161 to generate the transmission-rate-fixation request, and causes the selection unit 163 to select and output to the modulation unit 17 the fixed-transmission-rate request generated by the transmission-rate-fixation-request generating unit 161.

The modulation unit 17 modulates the transmission-rate-fixation request input, and outputs the modulated transmission-rate-fixation request to the radio frequency circuit 13. At this time, the radio frequency circuit 13 receives from the media access control unit 15 the instruction indicating the transmission mode, converts the modulated transmission-rate-fixation request into the radio frequency signal, and outputs the radio frequency signal to the antenna selector switch 12. The antenna selector switch 12 transmits, via the antenna currently selected, to the second wireless communication device 2 the radio frequency signal input from the radio frequency circuit 13.

The second wireless communication device 2 receives through antenna 21 the radio frequency signal transmitted from the first wireless communication device 1. The radio frequency circuit 22 converts the radio frequency signal received through the antenna 21 into the modulated reception signal, and outputs the modulated reception signal to the demodulation unit 23 according to the control mode indicated by the media access control unit 24 (in this case, a reception mode). The demodulation unit 23 demodulates the modulated reception signal input from the radio frequency circuit 22. The fixation-request determining unit 26 determines whether the reception data input from the demodulation unit 23 is the transmission-rate-fixation request or the transmission-rate-fixation-cancellation request.

In this case, the input is the transmission-rate-fixation request, and thus the fixation-request determining unit 26 instructs the modulation unit 25 to perform transmission with the transmission rate fixed. The media access control unit 24 receives the transmission-rate-fixation request output from the demodulation unit 23, generates and outputs the response signal to the modulation unit 25, and also switches the mode of the radio frequency circuit 22 to the transmission mode.

The modulation unit 25 modulates, with the transmission rate fixed, the response signal output from the media access control unit 24, and then outputs the modulated response signal to the radio frequency circuit 22. The radio frequency circuit 22 converts the modulated response signal input from the modulation unit 25 into the radio frequency signal, and transmits the radio frequency signal to the first wireless communication device 1 via the antenna 21. Afterward, the modulation unit 25 modulates, with the transmission rate fixed, the data received from an external device via the media access control unit 24, and then outputs a modulated data signal to the radio frequency circuit 22. The radio frequency circuit 22 converts the modulated data signal input from the modulation unit 25 into the radio frequency signal, and transmits the radio frequency signal to the first wireless communication device 1 via the antenna 21.

(Step S406) The first wireless communication device 1, while sequentially switching the antenna selector switch 12 by the control of the antenna control unit 19, receives through all the antennas one by one the response signal or the modulated data signal transmitted through the antenna 21 of the second wireless communication device 2. The response signal or the modulated data signal received through each antenna are processed by the antenna selector switch 12, the radio frequency circuit 13, and the demodulation unit 14 as described above, and then the error rate detection unit 18 measures the error rate for each antenna. It is to be noted that for the measurement of the error rate, it is preferable to use the modulated data signal which requires a longer reception time than to use the response signal which requires a shorter reception time. The processing is advanced to Step S407 when the measurement for each antenna is completed.

(Step S407) The antenna control unit 19 selects the lowest error rate from among the error rates, each of which the error rate detection unit 18 has measured for a corresponding one of antennas included in the group of antennas 11, and controls the antenna selector switch 12 so that the antenna which corresponds to the lowest error rate is selected.

(Step S408) The antenna control unit 19 instructs the transmission-rate-fixation requesting unit 16 to generate the transmission-rate-fixation-cancellation request. Upon receiving the instruction from the antenna control unit 19, the transmission-rate-fixation requesting unit 16 causes the transmission-rate-fixation-cancellation-request generating unit 162 to generate the transmission-rate-fixation-cancellation request. Further, the transmission-rate-fixation requesting unit 16 causes the selection unit 163 to select and output to the modulation unit 17 the transmission-rate-fixation-cancellation request generated by the transmission-rate-fixation-cancellation-request generating unit 162. The transmission-rate-fixation-cancellation request input to the modulation unit 17 is transmitted to the second wireless communication device 2 via the radio frequency circuit 13, the antenna selector switch 12, and the antenna selected by the antenna selector switch 12.

In the second wireless communication device 2, the transmission-rate-fixation-cancellation request is input to the fixation-request determining unit 26 via the antenna 21, the radio frequency circuit 22, and the demodulation unit 23. The fixation-request determining unit 26 determines that the data input is the transmission-rate-fixation-cancellation request, and issues to the modulation unit 25 an instruction to allow the variation in the transmission rate. The modulation unit 25 receives from the fixation-request determining unit 26 the instruction, and cancels the modulation processing performed with the transmission rate fixed.

It is to be noted that in FIG. 4, the processing of S408 may be performed chronologically before the processing of S407.

As described above, while the first wireless communication device 1 measures the error rate for each of a plurality of antennas searching for the antenna, the second wireless communication device 2 keeps the transmission rate constant. Accordingly, the measured error rates reflect the status of the wireless communication resulting in the accurate selection of the suitable antenna.

It is to be noted that although the structure in which one of a plurality of antennas is selected by the antenna selector switch is described in Embodiment 1, a structure in which a plurality of antennas are selected or a structure which includes no antenna selector switch may be adopted. Examples are described hereinafter.

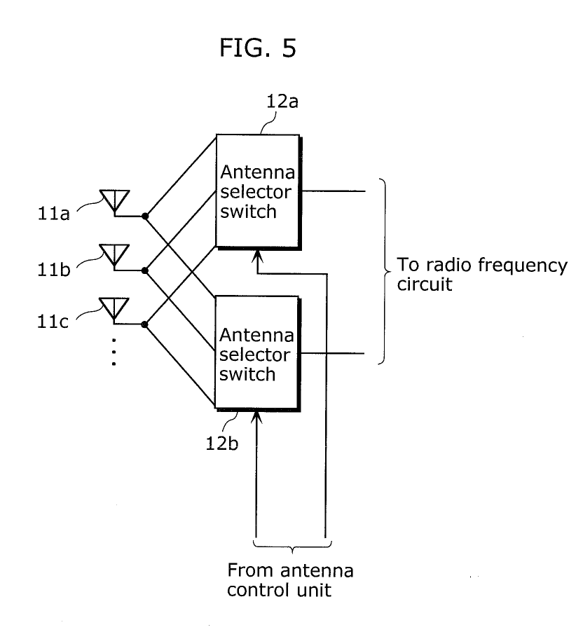

FIG. 5 is a portion which corresponds to the group of antennas 11 and the antenna selector switch 12 in FIG. 1. As shown in FIG. 5, providing a plurality of antenna selector switches 12a and 12b makes it possible to select a plurality of antennas 11a, 11b, and 11c in combination to be connected to the radio frequency circuit 13. Such a structure can handle a MIMO (Multiple Input Multiple Output) wireless communication system.

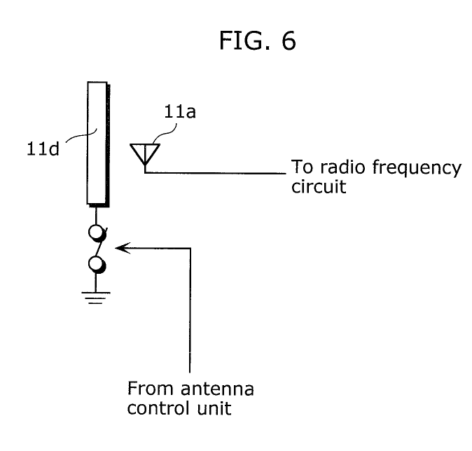

FIG. 6 is a portion which corresponds to the group of antennas 11 and the antenna selector switch 12 in FIG. 1. A passive element lid is placed near an antenna 11a, and the directivity of the antenna is changed by changing the grounding state of the passive element 11d. Thus, the same effect can be obtained as the example of FIG. 5 in which one antenna is selected from among the antennas having different directivities.

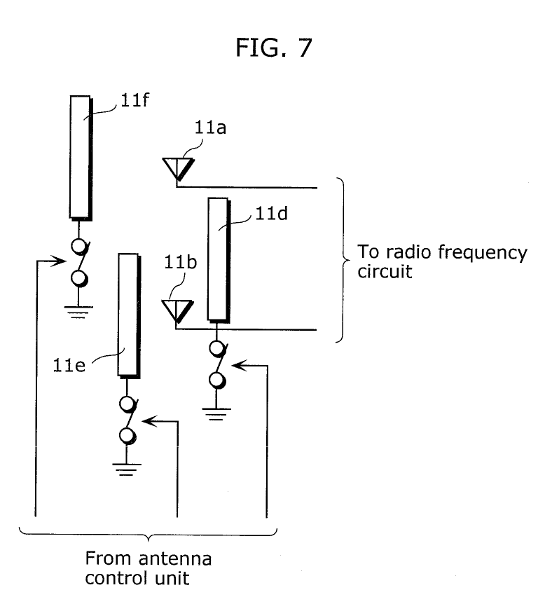

FIG. 7 is a portion which corresponds to the group of antennas 11 and the antenna selector switch 12 in FIG. 1. The passive elements 11d, 11e, and 11f are placed near the antennas 11a and 11b (the numbers of the antennas and the passive elements may be the same or different), and the directivity of the antenna is changed by changing the grounding state of the passive elements 11d, 11e, and 11f. Thus, the same effect can be obtained as the case where the antenna is switched. This structure can handle the MIMO wireless communication system.

### Embodiment 2

In Embodiment 1, the first wireless communication device 1 explicitly specifies the transmission rate for the second wireless communication device 2. However, in Embodiment 2, the transmission rate is indirectly specified. In Embodiment 2, the first wireless communication device 1 determines whether or not to transmit the response signal, which is transmitted in response to the wireless signal transmitted from the second wireless communication device 2 to the first wireless communication device 1, so as to cause the transmission rate of the wireless signal transmitted from the second wireless communication device 2 to become constant.

Except for the transmission-rate-fixation requesting unit 16, the structure of the wireless communication system and the two wireless communication devices 1 and 2 according to Embodiment 2 is the same as the structure described in Embodiment 1. Accordingly, the description thereof will be omitted.

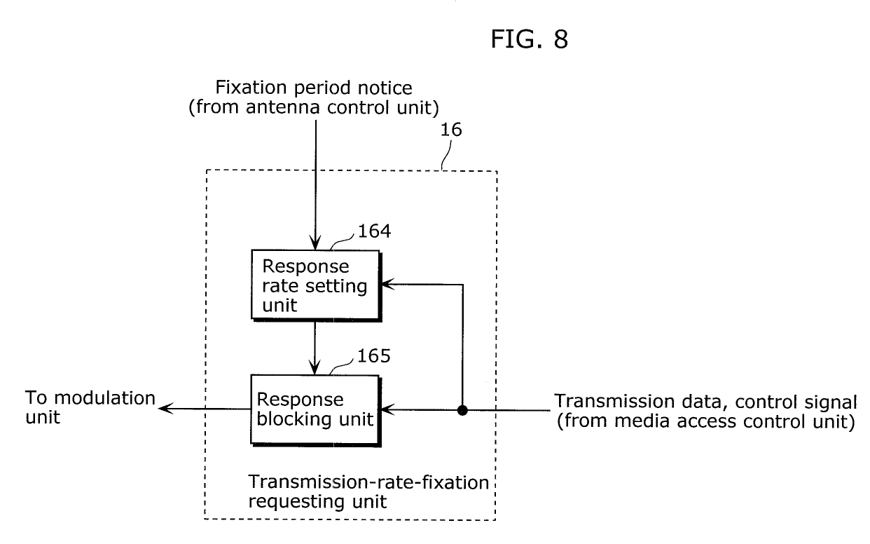

FIG. 8 is a block diagram showing an example of a structure of the transmission-rate-fixation requesting unit 16 according to Embodiment 2. The transmission-rate-fixation requesting unit (transmission rate controlling unit) 16 according to Embodiment 2 increases or decreases a rate of transmission of the response signal with respect to the wireless signal for causing the second wireless communication device 2 to keep the transmission rate constant. In other words, the transmission-rate-fixation requesting unit 16 changes a response rate which is a rate at which the wireless transmission and reception unit transmits the response signal generated by the media access control unit 15. More specifically, the transmission-rate-fixation requesting unit 16 decreases the response rate when the transmission rate exceeds a predetermined target value. On the other hand, the transmission-rate-fixation requesting unit 16 increases the response rate when the transmission rate falls short of the predetermined target value.

In FIG. 8, the response rate setting unit 164 included in the transmission-rate-fixation requesting unit 16 sets the response rate based on a fixation period notice input from the antenna control unit 19, and the transmission data or a control signal input from the media access control unit 15. Based on the information from the response rate setting unit 164, a response blocking unit 165 included in the transmission-rate-fixation requesting unit 16 either outputs to or blocks from the modulation unit 17 the transmission data or the control signal input from the media access control unit 15.

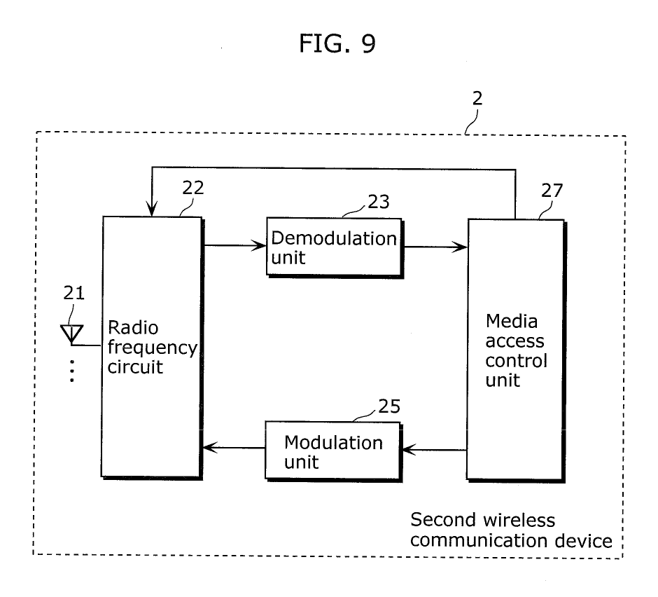

FIG. 9 is a block diagram showing an example of a structure of the second wireless communication device 2 according to Embodiment 2. The second wireless communication device 2 according to Embodiment 2 includes: the antenna 21; the radio frequency circuit 22; the demodulation unit 23; the modulation unit 25; and a media access control unit 27.

As shown in FIG. 9, the difference between the second wireless communication device 2 according to Embodiment 1 and the second wireless communication device 2 according to Embodiment 2 is whether the fixation-request determining unit 26 is included or not. In FIG. 9, the elements which perform the same operations as those in Embodiment 1 are given the same reference signs, and the description thereof will be omitted. In FIG. 9, the media access control unit 27 verifies the response rate of the response signal input from the demodulation unit 23, and adjusts the transmission rate to be used by the modulation unit 25.

Hereinafter, the operations of the first and second wireless communication devices 1 and 2 according to Embodiment 2 are described.

In Embodiment 2, a case where the first wireless communication device 1 switches the antennas while the wireless communication is performed between the first wireless communication device 1 and the second wireless communication device 2 is described as an example.

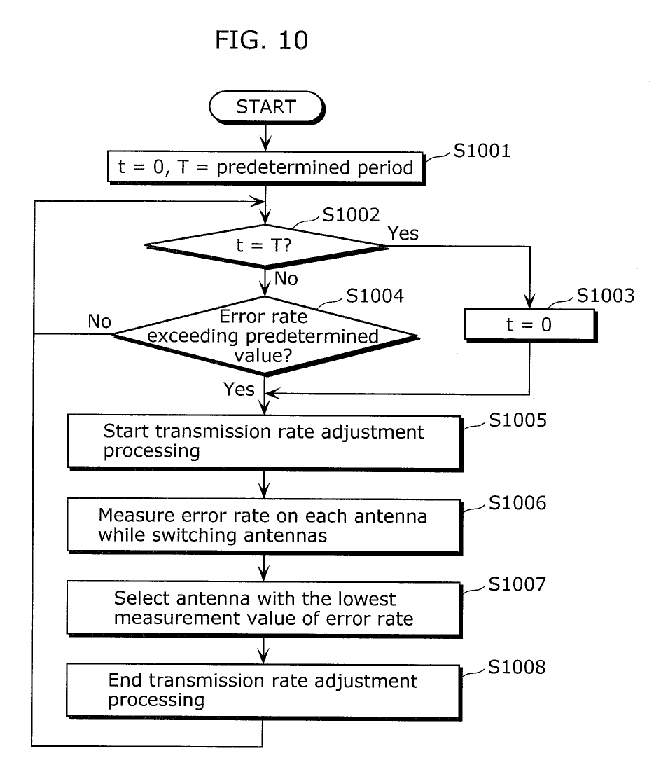

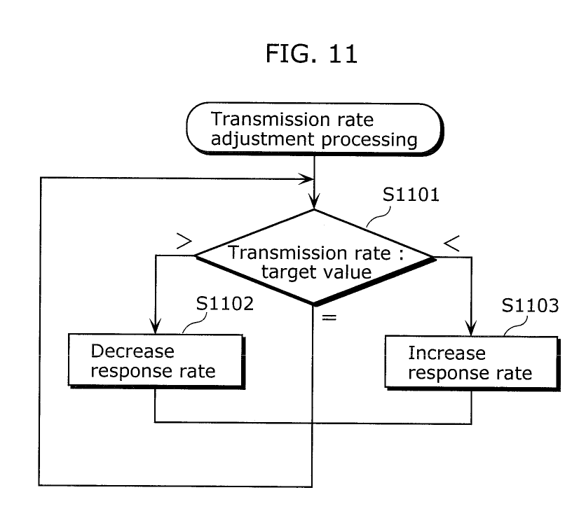

Hereinafter, the operations in Embodiment 2 are described in detail with reference to the flowcharts in FIG. 10 and FIG. 11. It is to be noted that FIG. 10 describes the operation of the first wireless communication device 1. In addition, FIG. 11 is a flowchart showing transmission rate adjustment processing, which is performed in parallel while the antenna switching processing shown in FIG. 10 is performed.

Now, it is assumed that the wireless communication is performed between the first wireless communication device 1 and the second wireless communication device 2, and that each of components in the first wireless communication device 1 and the second wireless communication device 2 performs the necessary processing.

(Step S1001) The antenna control unit 19 sets t(≧0)=0 and T(>0)=predetermined period so that the antenna control unit 19 can start a search for the suitable antenna periodically.

(Step S1002) The antenna control unit 19 checks whether the predetermined time has passed (whether t=T). When t=T (Yes in S1002), the processing proceeds to Step S1003. When t≠T (No in S1002), the processing proceeds to Step S1004.

(Step S1003) Because the predetermined time has passed, the antenna control unit 19 starts the search for the antenna. The antenna control unit 19 sets t=0, and causes the processing to proceed to Step S1005.

(Step S1004) When the reception data is input from the demodulation unit 14, the error rate detection unit 18 calculates an error rate such as a bit error rate or a packet error rate of the reception data, and determines whether the calculated error rate exceeds a predetermined value. When the error rate detection unit 18 determines that the calculated error rate exceeds the predetermined value (Yes in S1004), the processing proceeds to Step S1005. When the error rate detection unit 18 determines that the calculated error rate is equal to or smaller than the predetermined value (No in S1004), the processing returns to Step S1002.

(Step S1005) The antenna control unit 19 causes the transmission-rate-fixation requesting unit 16 to start the transmission rate adjustment processing. The transmission rate adjustment processing is a process for changing the response rate of the response signal for causing the transmission rate to become constant. More specifically, the transmission-rate-fixation requesting unit 16 decreases the response rate when the transmission rate exceeds the predetermined target value. On the other hand, the transmission-rate-fixation requesting unit 16 increases the response rate when the target value falls short of the predetermined target value.

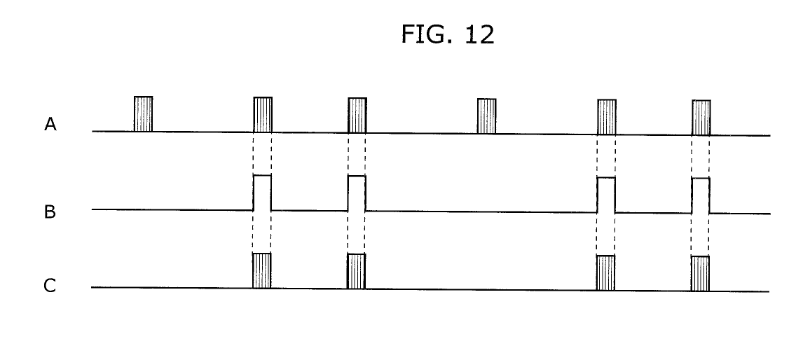

Hereinafter, the transmission rate adjustment processing is described in detail with reference to FIG. 11 and FIG. 12. FIG. 11 is a flowchart showing the transmission rate adjustment processing. FIG. 12 is a diagram showing a relationship between the response rate and the response signal according to Embodiment 2.

(Step S1101) The transmission-rate-fixation requesting unit 16 compares the transmission rate, which is set in a received wireless signal, with the predetermined target value. The target value may be a transmission rate at the time when the transmission rate adjustment processing is started or any value that is optimal for the search for the antenna.

Next, the processing proceeds to Step S1102 when the transmission rate exceeds the target value (“>” in S1101), and the processing proceeds to Step S1103 when the transmission rate falls short of the target value (“<” in S1101). On the other hand, when the transmission rate and the target value are the same (“=” in S1101), the processing returns to Step S1101 and repeats the same process to the next wireless signal.

(Step S1102) The response rate setting unit 164 decreases the response rate of the response signal when the transmission rate exceeds the target value. A range of decrease in response rate may always be constant. Alternatively, the range of decrease may be larger as the difference between the transmission rate and the target value becomes larger, and the range of decrease may be smaller as the difference between the transmission rate and the target value becomes smaller.

Specific processing performed by the transmission-rate-fixation requesting unit 16 is described with reference to FIG. 12. The line A in FIG. 12 indicates the response signal input from the media access control unit 15. The line B in FIG. 12 indicates the response signal permitted by the response rate setting unit 164. The line C in FIG. 12 indicates the response signal which is output to the modulation unit 17 through the response blocking unit 165.

In other words, according to FIG. 12, because the response rate is adjusted to ⅔, only ⅔ of the response signals generated by the media access control unit 15 are output to the modulation unit 17. The response signal output from the response blocking unit 165 is transmitted to the second wireless communication device 2 via the modulation unit 17, the radio frequency circuit 13, antenna selector switch 12, and the group of antennas 11.

The second wireless communication device 2 receives through the antenna 21 the response signal transmitted from the first wireless communication device 1. The response signal received through the antenna 21 is input to the media access control unit 27 via the radio frequency circuit 22 and the demodulation unit 23. The media access control unit 27 verifies the response rate of the response signal transmitted from the first wireless communication device 1. When the response rate is low, the media access control unit 27 determines that the transmission rate is too high for the first wireless communication device 1 to perform modulation properly, and decreases the transmission rate. (In reality, the first wireless communication device 1 deliberately decreases the response rate, however, many of the wireless communication devices are designed to decrease a transmission rate when a response rate decreases.)

The above described control by the media access control unit 27 makes it possible to immediately return the transmission rate to a low value even when the transmission rate is increased temporarily. Thus, the transmission rate can be kept approximately constant. Afterward, the modulation unit 25 modulates, with the transmission rate fixed, the data received from the external device via the media access control unit 24, and then outputs the modulated data signal to the radio frequency circuit 22. The radio frequency circuit 22 converts the modulated data signal input from the modulation unit 25 into the radio frequency signal, and transmits the radio frequency signal to the first wireless communication device 1 via the antenna 21.

(Step S1103) The response rate setting unit 164 increases the response rate of the response signal when the transmission rate falls short of the target value. The range of increase in response rate is the same as the range of decrease, and thus the description thereof will be omitted. It is to be noted that the transmission-rate-fixation requesting unit 16 may explicitly transmit the “transmission-rate-increase request” because the response rate does not immediately rise even when the response rate setting unit 164 increases the transmission rate.

The transmission-rate-fixation requesting unit 16 continuously performs the above described transmission rate adjustment processing until the search for the antenna is completed. Thus, the transmission rate of the wireless signal output from the second wireless communication device 2 during the search for the antenna is kept constant.

It is to be noted that FIG. 12 shows the example where the target value for decreasing the response rate is the same as the target value for increasing the response rate, however, the present invention is not limited to the above. The transmission-rate-fixation requesting unit 16 may decrease the response rate when the transmission rate exceeds an upper limit, and increase the response rate when the transmission rate falls short of a lower limit (<upper limit). Thus, the transmission rate may be kept within a certain range (between the lower limit and the upper limit).

(Step S1006) The first wireless communication device 1, while sequentially switching the antenna selector switch 12 by the control of the antenna control unit 19, receives through all the antennas one by one the response signal or the modulated data signal transmitted from the antenna 21 of the second wireless communication device 2. The response signal and the modulated data signal received through each antenna are processed by the antenna selector switch 12, the radio frequency circuit 13, and the demodulation unit 14 as described above, and then the error rate detection unit 18 measures the error rate for each antenna. The processing proceeds to Step 51007 when the measurement of the error rate of each antenna is completed.

(Step S1007) The antenna control unit 19 selects the lowest error rate from among the error rates, each of which the error rate detection unit 18 has measured for a corresponding one of antennas included in the group of antennas 11, and controls the antenna selector switch 12 so that the antenna which corresponds to the lowest error rate is selected.

(Step S1008) The antenna control unit 19 instructs the transmission-rate-fixation requesting unit 16 to send back all the response signals. In other words, the antenna control unit 19 ends the transmission rate adjustment processing. The transmission-rate-fixation requesting unit 16 instructs the response rate setting unit 164 to send back all the response signals. The response rate setting unit 164 determines to send back all the response signals from the media access control unit 15. The response blocking unit 165 stops blocking the response signals according to the instruction from the response rate setting unit 164.

It is to be noted that, in FIG. 10, the processing of S1008 may be performed chronologically before the processing of S1007.

Here, in the first wireless communication device 1, a desirable criterion for determining that the transmission rate is high, and a desirable rate for sending back the response signal are described.

In general, there is a required throughput depending on the content (such as video and audio) to be transmitted from the second wireless communication device 2 to the first wireless communication device 1, and such throughput can be converted into required minimum transmission rate based on the transmission efficiency of a media access layer or a physical layer. It may be determined that the “transmission rate is high” if the required minimum transmission rate is exceeded. Moreover, a predetermined rate that is a rate for sending back the response signal should be set so that a throughput does not decrease drastically when the predetermined rate is applied. More specifically, the predetermined rate should roughly be in a range between less than 100% and 50% or more, instead of zero.

As described above, in Embodiment 2, the second wireless communication device 2 keeps the transmission rate constant while the first wireless communication device 1 measures the error rate for each of a plurality of antennas searching for the antenna. As a result, the error rates reflect the status of the transmission rate, and therefore the first wireless communication device 1 can select the suitable antenna accurately. Further, the first wireless communication device 1 does not explicitly send the second wireless communication device 2 an instruction regarding the transmission rate. In other words, since the second wireless communication device 2 does not need to respond to the instruction regarding the transmission rate, the second wireless communication device 2 may be a general wireless communication device with no special structure, such as an access point for wireless LAN (Local Area Network).

It is to be noted that although the structure in which one of the antennas is selected from among the plurality of antennas by the antenna selector switch is described in Embodiment 2, a structure in which a plurality of antennas are selected, or a structure in which no antenna selector switch is used may also be adopted. More specifically, the structures are the same as FIG. 5 to FIG. 7 described in Embodiment 1.

Furthermore, in the examples of Embodiment 1 and 2, the transmission rate of the second wireless communication device 2 is kept constant during the antenna search processing, however, the present invention is not limited to this. In other words, the transmission rate adjustment processing of the present invention may be widely applied to the wireless communication in a situation where the transmission rate of the wireless signal transmitted from the counterpart device needs to be controlled. For example, the present invention may be applied when the wireless communication device needs to accurately measure the communication status with the counterpart device, or when the wireless communication device needs to decrease the transmission rate from the counterpart device so as to lower the processing load of a wireless communication device or of an equipment connected thereof.

Moreover, the wireless communication devices described in Embodiments 1 and 2 can be typically realized as an LSI (Large Scale Integration) which is an integrated circuit. These may be made as separate individual chips, or as a single chip to include a part or all thereof.

In addition, the LSI may also be called IC, system LSI, super LSI, or ultra LSI depending on the degree of integration.

Moreover, ways to achieve integration are not limited to the LSI, and special circuit or general purpose processor can also achieve the integration. It is also acceptable to use an FPGA (Field Programmable Gate Array) that is programmable after the LSI has been manufactured, and a reconfigurable processor in which connections and settings of circuit cells within the LSI are reconfigurable.

In the future, if integrated circuit technology that replaces LSI appear through progress in semiconductor technology or other derived technology, that technology can naturally be used to carry out integration of functional blocks. Application of biotechnology is one such possibility.

As described above, the embodiments of the present invention have been described with reference to the drawings, however, the present invention is not limited to the embodiments shown in the drawings. To the embodiments shown in the drawings, it is possible to make various modifications and changes within the identical scope or within the equivalent scope of the present invention.

### INDUSTRIAL APPLICABILITY

The wireless communication device according to the present invention allows highly reliable communication when receiving the wireless signal transmitted by the wireless communication device which has a function of changing the transmission rate of the wireless signal, and is useful as a wireless LAN device and the like. Moreover, the wireless communication device according to the present invention can also be applied to the wireless communication of image, audio, and the like.

### REFERENCE SIGNS LIST

1, 2 Wireless communication device

11 Group of antennas

11a, 11b, 11c, 21 Antenna

11d, 11e, 11f Passive element

12, 12a, 12b Antenna selector switch

13, 22 Radio frequency circuit

14, 23 Demodulation unit

15, 24, 27 Media access control unit

16 Transmission-rate-fixation requesting unit

17, 25 Modulation unit

18 Error rate detection unit

19 Antenna control unit

26 Fixation-request determining unit

161 Transmission-rate-fixation-request generating unit

162 Transmission-rate-fixation-cancellation-request generating unit

163 Selection unit

164 Response rate setting unit

165 Response blocking unit

1. A wireless communication device which performs wireless communication with an other wireless communication device connected via a wireless network, said wireless communication device comprising:
a wireless transmission and reception unit configured to transmit and receive a wireless signal;
a transmission rate controlling unit configured to control the other wireless communication device so that a transmission rate of the wireless signal becomes constant, the wireless signal being transmitted by the other wireless communication device and received by said wireless transmission and reception unit; and
a response generating unit configured to generate a response signal for notifying the other wireless communication device of the reception of the wireless signal, and to cause said wireless transmission and reception unit to transmit the response signal,
wherein said transmission rate controlling unit is configured to increase or decrease a rate of the response signal with respect to the wireless signal so that the transmission rate of the other wireless communication device is kept constant.

2. (canceled)

3. The wireless communication device according to claim 1,
wherein said transmission rate controlling unit is configured to decrease a response rate which is the rate at which said wireless transmission and reception unit transmits the response signal generated by said response generating unit, when the transmission rate exceeds a predetermined target value.

4. The wireless communication device according to claim 3,
wherein said transmission rate controlling unit is further configured to increase the response rate when the transmission rate falls short of the predetermined target value, and cause said wireless transmission and reception unit to transmit a transmission-rate-increase request for causing the other wireless communication device to increase the transmission rate.

5. The wireless communication device according to claim 3,
wherein said transmission rate controlling unit is configured to set the response rate to 50% or greater.

6. The wireless communication device according to claim 1,
wherein said wireless transmission and reception unit includes an antenna which has a plurality of directivities that can be mutually switched,
said wireless communication device further comprises a directivity selection unit configured to perform a directivity selection processing of measuring an error rate while sequentially switching the directivities of said antenna and selecting a directivity with a lowest error rate as a directivity of said antenna, and
said transmission rate controlling unit is configured to control the other wireless communication device so that the transmission rate is kept constant while the directivity selection processing is performed.

7. A wireless communication device which performs wireless communication with an other wireless communication device connected via a wireless network, said wireless communication device comprising:
a wireless transmission and reception unit configured to transmit and receive a wireless signal, said wireless transmission and reception unit including an antenna which has a plurality of directivities that can be mutually switched;
a transmission rate controlling unit configured to control the other wireless communication device so that a transmission rate of the wireless signal becomes constant, the wireless signal being transmitted by the other wireless communication device and received by said wireless transmission and reception unit; and
a directivity selection unit configured to perform a directivity selection processing of measuring an error rate while sequentially switching the directivities of said antenna and selecting a directivity with a lowest error rate as a directivity of said antenna,
wherein said transmission rate controlling unit is configured to cause said wireless transmission and reception unit to transmit a transmission-rate-fixation request for causing the other wireless communication device to fix the transmission rate, the transmission-rate-fixation request being transmitted when said directivity selection unit starts the directivity selection processing.

8. A wireless communication device which is the other communication device connected with the wireless communication device according to claim 7 via a wireless network, said wireless communication device comprising:
a wireless transmission and reception unit configured to transmit and receive a wireless signal;
a transmission rate setting unit configured to set a transmission rate of the wireless signal, and cause said wireless transmission and reception unit to transmit the wireless signal at the set transmission rate; and
a transmission rate controlling unit configured to prohibit, in response to the reception of the transmission-rate-fixation request, said transmission rate setting unit from changing the transmission rate.

9. A wireless communication method for performing wireless communication with an other wireless communication device connected via a wireless network, said wireless communication method comprising:
transmitting and receiving a wireless signal;
controlling the other wireless communication device so that a transmission rate of the wireless signal becomes constant, the wireless signal being transmitted by the other wireless communication device and received in said transmitting and receiving; and
transmitting a response signal for notifying the other wireless communication device of the reception of the wireless signal,
wherein in said controlling, a rate of the response signal with respect to the wireless signal is increased or decreased so that the transmission rate of the other wireless communication device is kept constant.

10. A non-transitory computer-readable recording medium for use in a computer, and having a computer program recorded thereon for causing the computer to perform wireless communication with a wireless communication device connected via a wireless network, the program causing the computer to execute:
transmitting and receiving a wireless signal;
controlling the wireless communication device so that a transmission rate of the wireless signal becomes constant, the wireless signal being transmitted by the wireless communication device and received in said transmitting and receiving; and
transmitting a response signal for notifying the wireless communication device of the reception of the wireless signal,
wherein in said controlling, a rate of the response signal with respect to the wireless signal is increased or decreased so that the transmission rate of the wireless communication device is kept constant.

11. An integrated circuit which performs wireless communication with an other wireless communication device connected via a wireless network, said integrated circuit comprising:
a wireless transmission and reception unit configured to transmit and receive a wireless signal;
a transmission rate controlling unit configured to control the other wireless communication device so that a transmission rate of the wireless signal becomes constant, the wireless signal being transmitted by the other wireless communication device and received by said wireless transmission and reception unit; and
a response generating unit configured to generate a response signal for notifying the other wireless communication device of the reception of the wireless signal, and to cause said wireless transmission and reception unit to transmit the response signal,
wherein said transmission rate controlling unit is configured to increase or decrease a rate of the response signal with respect to the wireless signal so that the transmission rate of the other wireless communication device is kept constant.
